(19) United States
(12) Patent Application Publication
(10) Pub. No.: US 2022/0285772 A1
(43) Pub. Date: Sep. 8, 2022

(54) BATTERY CASE FOR ELECTRIC VEHICLE, AND METHOD FOR MANUFACTURING SAME

(71) Applicant: KABUSHIKI KAISHA KOBE SEIKO SHO (KOBE STEEL, LTD.), Hyogo (JP)

(72) Inventor: Hideki ISHITOBI, Kobe-shi, Hyogo (JP)

(73) Assignee: KABUSHIKI KAISHA KOBE SEIKO SHO (KOBE STEEL, LTD.), Hyogo (JP)

(21) Appl. No.: 17/631,337

(22) PCT Filed: Jun. 23, 2020
(86) PCT No.: PCT/JP2020/024627

§ 371 Date: Jan. 28, 2022

(30) Foreign Application Priority Data
Jul. 31, 2019 (JP) 2019-141170

(51) Int. Cl. H01M 50/231; H01M 50/209; H01M 50/224; H01M 50/249; B21D 22/02

(52) U.S. Cl. CPC H01M 50/231; H01M 50/209; H01M 50/224; H01M 50/249; B21D 22/02; H01M 2220/20

(57) ABSTRACT

A method for manufacturing a battery case for electric vehicle includes: preparing a frame, and a blank material formed in a flat plate shape; disposing the frame and the blank material to stack the blank material on the frame; and pressurizing the blank material to press the blank material against the frame, so as to mold the blank material into a bathtub shape and joining the blank material to the frame by press-fitting.

### TECHNICAL FIELD

The present invention relates to a battery case for electric vehicle and a method for manufacturing the battery case for electric vehicle.

### BACKGROUND ART

An electric vehicle such as an electric car needs to be equipped with a large capacity battery to secure a sufficient running distance while the electric vehicle is required to have a large vehicle cabin. In order to fulfill these requirements, in many cases, the electric vehicle is equipped with the large capacity battery stored in a battery case that is disposed in an entire underfloor region of the electric vehicle. Accordingly, the battery case electric vehicle is required to have enhanced sealability, so as to prevent inclusion of water from a road surface or others and thus prevent malfunction an electronic component. Concurrently, the battery case for electric vehicle is required to have greater collision strength to protect the large capacity battery therein.

For example, Patent Document 1 discloses a battery case including a tray made of a metal plate that has been cold press molded into a bathtub shape, so that sealability of the battery case is increased. Patent Document 2 discloses a battery case having a bottom plate and a frame joined to each other by welding or other joining means, so that space efficiency and collision strength of the battery case are increased.

### PRIOR ART DOCUMENT

### Patent Documents

Patent Document 1: JP 2017-226353 A

Patent Document 2: JP 2012-212659 A

### SUMMARY

### Problems to be Solved by the Invention

In the battery case disclosed in Patent Document 1, the metal plate is cold press molded into the bathtub shape, thereby requiring the tray to have a draft angle (inclination of a side surface of the tray) for release of a die and requiring a ridgeline and a corner of a bottom of the tray to be rounded. Thus, space efficiency for mounting a battery can not be increased. Further, the tray having the bathtub shape needs to be joined to a longitudinal rib, which is a frame, by welding or other means.

In the battery case disclosed in Patent Document 2, the welding or other joining means may cause thermal deformation. Thus, the battery case requires additional steps of inspecting and correcting sealing accuracy, joining accuracy, and the like.

An object of the present invention is to provide a battery case for electric vehicle and a method for manufacturing the battery case for electric vehicle, in which sufficient sealability is secured and, concurrently, simple and highly accurate joining is ensured.

### Means for Solving the Problems

A first aspect of the present invention provides a method for manufacturing a battery case for electric vehicle, the method including:
preparing a frame, and a blank material formed in a flat plate shape;
disposing the frame and the blank material to stack the blank material on the frame; and
pressurizing the blank material to press the blank material against the frame, so as to mold the blank material into a bathtub shape and joining the blank material to the frame by press-fitting.

With this method, the blank material is molded into the bathtub shape and, concurrently, is integrally formed with the frame. The blank material having the flat plate shape is molded into the bathtub shape, so that the blank material having the bathtub shape has no joint and is thus highly sealable. Additionally, the blank material is molded into the bathtub shape and concurrently, is joined to the frame, thereby simplifying the step of joining the blank material to the frame. The blank material is joined to the frame not by welding but by press-fitting, so that the joining is highly accurate without any thermal deformation. Accordingly, with the method for manufacturing the battery case for electric vehicle, sufficient sealability of the battery case is secured; and concurrently, the blank material molded into the bathtub shape is simply and highly accurately joined to the frame.

The blank material may be pressurized based on a pressure molding method.

Here, with the pressure molding method, the blank material having the bathtub shape is no longer required to have a draft angle (inclination of side surface) as well as a ridgeline and a corner of the blank material having the bathtub shape may be less rounded, which is difficult to achieve in a typical cold press molding. Thus, it is possible to mold the blank material into any bathtub shape. The blank material having the bathtub shape is no longer required to have the draft angle, and may have the ridgeline less rounded. Thus, space efficiency of the battery case is increased, resulting in the battery case equipped with a larger capacity battery. In the pressure molding method, a member is molded by air or fluid pressure.

The method for manufacturing the battery case for electric vehicle may further include: further preparing a fluid pressure transmitting elastic body that is elastically deformable under the fluid pressure; disposing the fluid pressure transmitting elastic body to stack it on the blank material that has been stacked on the frame; and pressurizing the blank material via the fluid pressure transmitting elastic body to press the blank material against the frame.

With this method, when the blank material is molded into the bathtub shape, the fluid used for pressurization does not scatter or leak. Here, the fluid pressure transmitting elastic body may. For example, have a configuration where a chamber of metal containing the fluid therein has only its lower surface closed with a rubber plate. With the fluid pressure adjusted, the rubber plate is elastically deformed, and the blank material is molded without being brought into direct contact with the fluid. On an assumption that the fluid pressure transmitting elastic body is not used in the pressure molding method, when the blank material is deformed directly by the fluid held at high pressure, an outer edge of the blank material needs to be tightly restricted such that the fluid does not scatter or leak outside. On the other hand, with the fluid pressure transmitting elastic body, the fluid for applying force does not scatter or leak, so that the outer edge of the blank material may be less tightly restricted. Accordingly, when the blank material is molded into the bathtub shape, its material inflow from the outer edge is increased, and the blank material is less prone to crack, thereby facilitating stable processing. Further, the cuter edge of the blank material no longer needs to be completely sealed, so that maintenance of a pressing machine and a die for restricting the outer edge is easier, and productivity is improved.

Before the blank material is pressurized based on the pressure molding method, the blank material may be pressurized by cold press molding.

With this method, the blank material is molded in two separate steps in a stepwise manner. Here, pressurizing force is reduced as compared with a case where the blank material is completely molded in one step only, and the blank material is thus stably molded.

Between when the blank material is pressurized based on the pressure molding method (step 2) and when the blank material is pressurized by the cold press molding (step 1), the blank material may be subjected to softening heat treatment.

With this method, the softening heat treatment can remove a processing distortion of the blank material caused by the pressurization in the step 1. elasticity of the material can be restored, so that the ridgeline and the corners of the blank material having the bathtub shape may be less rounded.

When the blank material is molded into a tray having a bathtub shape, negative angle molding may be conducted to form a negative angle at least partially from a bottom of the tray toward an opening of the tray.

With this method, the negative angle is formed in the blank material having the bathtub shape, and due to the negative angle portion, the joining by press-fitting is less prone to be released. The “negative angle” is a term frequently used in a field of molding using a die, and indicates that the draft angle of the molded member for release of the die is less than zero (i.e., a minus angle). In other words, the negative angle molding is configured to increase strength of joining between the frame and the blank material having the bathtub shape. Particularly, the negative angle molding is a characteristic of the pressure molding method, while with the cold press molding using a typical die and requiring the draft angle, a cam mechanism is additionally required and a structure of the typical die is thus further complicated.

Before the blank material is pressurized, the frame may include the negative angle portion where the negative angle is previously formed, and, in the negative angle molding, the blank material may be pressed against the negative angle portion of the frame.

In this method, with the negative angle portion previously formed in the frame, the negative angle molding. is simply and reliably executed.

The negative angle molding may be conducted as follows: the blank material is pressurized to be integrally deformed with the frame, causing the negative angle to be formed.

With this method, the blank material and the frame are integrally deformed, causing the nevi rive angles to be formed. Here, the frame does not necessarily include the negative angle portion previously. Accordingly, the negative angle molding is simply executed.

The method for manufacturing the battery case for electric vehicle may further include: further preparing a restricting die having a height dimension greater than that of the frame and configured to restrict a movement of the frame; disposing the restricting die fixedly to an outer side of the frame; supporting a first outer edge of the blank material by the frame and supporting a second outer edge of the blank material by the restricting die, where the second outer edge is at an outer side of the first outer edge, so as to dispose the blank material in a state where the blank material is deflected to be lower in height from an outer side of the blank material toward an inner side of the blank material; and pressurizing the blank material in the state where the blank material is deflected.

With this method, in the state where the blank material is deflected to be lower in height from the outer side to the inner side, the blank material is pressurized. As a result, the material inflow of the blank material is increased, and the ridgeline and the corners at the bottom of the blank material having the bathtub shape may be less rounded.

A second aspect of the present invention provides a battery case for electric vehicle including: a frame; and a tray having a bathtub shape, disposed inside the frame, and joined to the frame by press-fitting. With the battery case for electric vehicle, in joining of the tray to the frame by press-fitting. The tray includes a negative angle portion where a negative angle is formed at least partially inward from a bottom of the tray toward an opening of the tray.

With this configuration, the tray of the bathtub shape is configured to increase sealability of the battery case; and the frame and the tray are integrally formed not by welding but by press-fitting, so that the joining of the tray to the frame is highly accurate without any dimensional change caused by thermal deformation. Further, with the tray including the negative angle portion, the joining by press fitting is less prone to be released, and the battery case for electric vehicle is increased in strength.

The frame may be formed of an aluminum alloy extruded product, an aluminum alloy cast product, a magnesium alloy extruded product, a magnesium alloy cast product, or a combination thereof; and the tray may be formed of an aluminum alloy or a magnesium alloy.

Here, the frame and the tray are both formed of aluminum alloy members or magnesium alloy members. With this configuration, the battery case is reduced in weight and concurrently, is no longer required for a countermeasure against electrolytic corrosion. Thus, the battery case is more easily handled.

The frame may be formed of a roll formed sheet steel material, a pressed sheet steel product, or a combination thereof; and the tray may be formed of a sheet steel.

Here, the frame and the tray are both formed of steel members. With this configuration, the battery case is reduced in cost and increased in strength and concurrently, is no longer required for the countermeasure against electrolytic corrosion. Thus, the battery case is more easily handled.

The frame may be formed of the aluminum alloy extruded product, the aluminum alloy cast product, the magnesium alloy extruded product, the magnesium alloy cast product, or the combination thereof; and the tray may be formed of a coated sheet steel or a laminated sheet steel.

Here, the frame is formed of the aluminum alloy member or the magnesium alloy member. Thus, the battery case is reduced in weight. Further, the tray is formed of the coated (or laminated) sheet steel, so that the battery case is reduced in cost and increased in strength and concurrently, the coating film prevents the electrolytic corrosion. Particularly, in a field of multi-material manufacturing. using different types of metals such as an aluminum alloy member with a steel member or a magnesium alloy member with a steel member, it is difficult to weld these different types of metals. On the other hand, with the configuration above, the frame and the tray are joined not by welding but by press-fitting, thereby enabling the multi-material manufacturing and resulting in the battery case that is reduced in weight and increased in strength.

The frame may include a cross member.

Here, the cross member is configured to increase the strength of the battery case. Particularly, the cross member is configured to increase the strength of the battery case against collision from a side of the electric vehicle.

### Effect of the Invention

With a battery case for electric vehicle and a method for manufacturing the battery case for electric vehicle, both according to the present invention, it is possible to secure sufficient sealability and ensure simple and highly accurate joining.

### BRIEF DESCRIPTION OF THE DRAWINGS

FIG. 1 is a side view of an electric car equipped with a battery case for electric vehicle according to a first embodiment of the present invention;

FIG. 2 is a schematic cross-sectional view of the battery case;

FIG. 3 is a perspective view of a tray and a frame;

FIG. 4 is an exploded perspective view of the tray and the frame;

FIG. 5 is a first cross-sectional view illustrating a method for manufacturing the battery case for electric vehicle according to the first embodiment;

FIG. 6 is a second cross-sectional view illustrating the method for manufacturing the battery case for electric vehicle according to the first embodiment;

FIG. 7 is a third cross-sectional view illustrating the method for manufacturing the battery case for electric vehicle according to the first embodiment;

FIG. 8 is a cross-sectional view illustrating a first modification of a negative angle molding;

FIG. 9 is a cross-sectional view illustrating a second. modification of the negative angle molding;

FIG. 10 is a perspective view of a restricting die and a frame;

FIG. 11 is an exploded perspective view of the restricting die and the frame;

FIG. 12 is a first cross-sectional view illustrating. a method for manufacturing a battery case for electric vehicle according to a second embodiment;

FIG. 13 is a second cross-sectional view illustrating the method for manufacturing the battery case for electric vehicle according to the second embodiment; and

FIG. 14 is a third cross-sectional view illustrating the method for manufacturing the battery case for electric vehicle according to the second embodiment.

### MODE FOR CARRYING OUT THE INVENTION

Embodiments of the present invention will be described below with reference to the appended drawings.

### (First Embodiment)

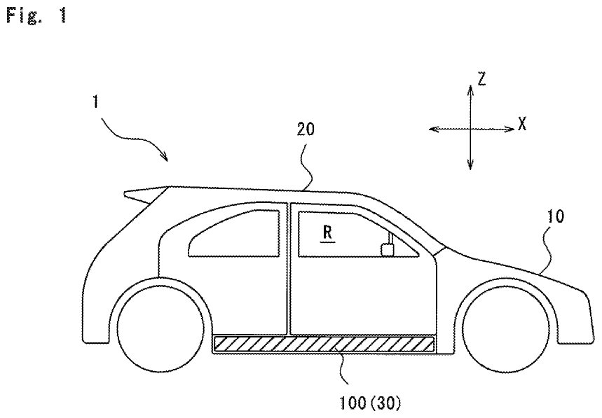

With reference to FIG. 1, an electric vehicle 1 is a vehicle configured to run on a motor driven by electric power supplied from a battery 30. The electric vehicle 1 is configured to run on the electric power, and may be, for example, an electric car or a plugin hybrid vehicle The electric vehicle 1 is not limited to a particular type, and may be a passenger car, a truck, a work vehicle, or any other mobile vehicle. Descriptions below will be given to an electric passenger car as an example of the electric vehicle 1.

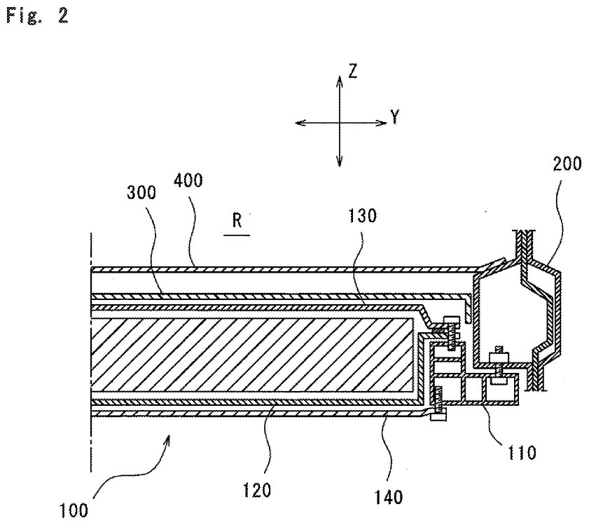

The electric vehicle 1 is equipped with a motor (not illustrated), a high voltage device (not illustrated) or others at a vehicle body front section 10. Additionally, the electric vehicle 1 is equipped with a battery case for electric vehicle 100 (hereinafter, will be simply referred to as a battery case 100) where the battery 30 is stored, and the battery case 100 is disposed in an entire underfloor region of a vehicle cabin R at a vehicle body central section 20. In FIG. 1, a longitudinal direction of the electric vehicle 1 is denoted with an X direction, and a height direction of the electric vehicle 1 is denoted with a Z direction. The same applies to FIG. 2 and all drawings subsequent to FIG. 2; additionally, in these drawings, a vehicle width direction is denoted with a Y direction.

With reference to FIG. 2, the battery case 100 is disposed at an inner side of a rocker member 200 in the vehicle width direction, and is supported by the rocker member 200. The rocker member 200 is a frame member disposed. at a lower portion of each end of the electric vehicle 1 (see FIG. 1) in the vehicle width direction and extending in the vehicle longitudinal direction of the electric vehicle 1. The rocker member 200 corresponds to a plurality of metal plates attached to each other, and has a function of protecting the vehicle cabin R and the battery case 100 against an impact from a side of the electric vehicle 1.

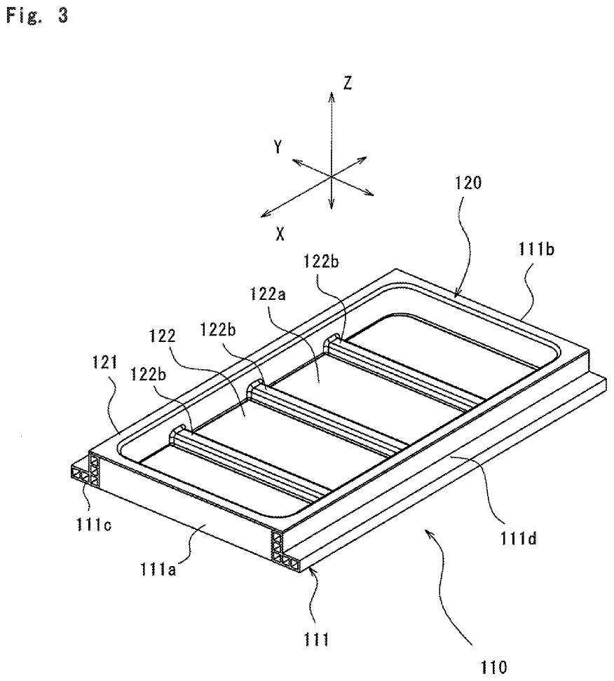

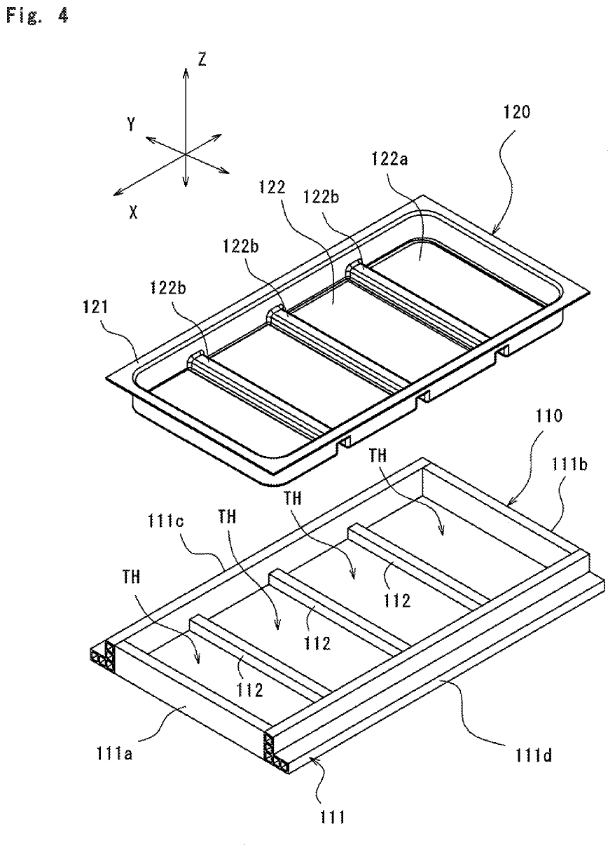

With reference to FIGS. 3 and 4, the battery case 100 includes a frame 110, a tray 120, a top cover 130, and an under cover 140. The frame 110 defines a through hole TH; the tray 120 has a bathtub shape; and the top cover 130 and the under cover 140 are respectively disposed to sandwich the frame 110 and the tray 120 from top and bottom.

The frame 110 is a frame shaped member as a frame of the battery case 100, and is formed of, for example, an aluminum alloy extruded product, an aluminum alloy cast product, a magnesium alloy extruded product, a magnesium alloy cast product, or a combination thereof. The frame 110 includes a frame shaped body 111 and three cross members 112. The frame shaped body 111 has a rectangular frame shape in plan view, and each of the three cross members 112 is disposed inside the frame shaped body 111 and extends in the vehicle width direction. In this embodiment, as an example, the frame 110 has the through hole TH therein, but the shape of the frame 110 is not particularly limited. For example, instead of the through hole TH, the frame 110 may have a hollow portion having a recessed shape.

The frame shaped body 11 includes a side wall 111c, a side wall 111d, a front wall 111a, and a rear wall 111b. Each of the side walls 111c and 111d extends in the vehicle longitudinal direction, and each of the front wail 111a and the rear wall 111b connects the side walls 111c and 111d and extends in the vehicle width direction. Each of the side walls 111c and 111d is substantially L-shaped in a cross section perpendicular to the vehicle longitudinal direction. Each of the side walls 111c and 111d has a hollow shape defined into a plurality of chambers. Each of the front wall 111a and the rear wall 111b has a cuboid shape, and has a hollow shape similarly to the side walls 111c and 111d.

The three cross members 112 are disposed parallel to the front wall 111a and rear wall 111b, are substantially evenly spaced from each other, and are configured to connect the side wall 111c and the side wall 111d. Each of the cross members 112 has a function of increasing a strength of the battery case 100. Particularly, each of the cross members 112 is configured to increase the strength against collision from the side of the electric vehicle 1 (see FIG. 1). Note that, each of the cross members 112 is not an essential component and may be omitted as needed. Further, when the cross members 112 are included, the cross members 112 are not provided in a particular manner, and may be formed in any shape, disposed in any manner, and provided in any quantity.

The tray 120, as a member of the bathtub shape, accommodates the battery 30 and is formed of the aluminum alloy or the magnesium alloy. The tray 120 includes a flange 121 and an accommodating portion 122. The flange 121 is disposed at an outer edge of the tray 120 and extends in a horizontal direction (the N and Y directions), and the accommodating portion 122 is disposed continuously to the flange 121 and has a recessed shape. The accommodating portion 122 is configured to accommodate the battery 30. The accommodating portion 122 includes a bottom 122a, and a protruding portion 122b on the bottom 122a. The protruding portion 122b has a shape complementary to each of the cross members 112.

In a state where the tray 120 and the frame 110 are combined (see FIG. 3), the flange 121 of the tray 120 is mounted on an upper surface of the frame shaped body 111 of the frame 110; and concurrently, the accommodating portion. 122 of the tray 120 is disposed in the frame shaped body 111 of the frame 110. In this state, the protruding portion 122b is disposed to partially cover each of the cross members 112. FIG. 4 is a virtual exploded view of the tray 120 and the frame 110 for convenience of description. The tray 120 is Mined by press-fitting to each of the through holes TH of the frame 110, so that the tray 120 and the frame 110 are combined to be integrally formed as illustrated in FIG. 3. In this joining by press-fitting, an outer surface of the accommodating portion 122 of the tray 120 is brought into pressure contact with an inner surface of the frame shaped body 111 of the frame 110, and concurrently, the protruding portion 122b is brought into pressure contact with each of the cross members 112.

With reference back to FIG. 2, the battery 30 is disposed in the accommodating portion 122 of the tray 120. When the accommodating portion 122 has been closed from above the battery 30 by the top cover 130, the battery 30 is stored in the battery case 100. FIG. 2 illustrates an example where the top cover 130 and the tray 120 are fastened and fixed with a screw to the frame 110. Above the top cover 130, a floor panel 300 and a floor cross member 400 are disposed. The floor panel 300 corresponds to a floor surface of the vehicle cabin R, and the floor cross member 400 is disposed in the vehicle cabin R and extends in the vehicle width direction. The under cover 140 is disposed below the tray 120. The under cover 140 is screwed to the frame 110 and supports the tray 120 from below.

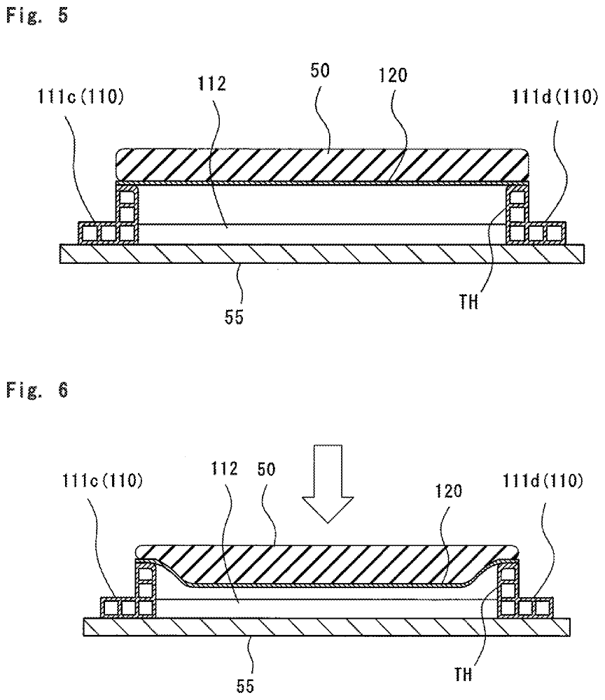

The battery case 100 has configurations described above, and with reference to FIGS. 5, 6, and 7, a method for manufacturing the battery case 100 will be described.

With reference to FIG. 5, the frame 110 having the frame shape and a blank material 120 having a flat plate shape are prepared, and the frame 110 and the blank material 120 are stacked and disposed on a base 55. Note that, the blank material and the tray are denoted with the same symbol 120. Here, the blank material corresponds to a form of the tray before being molded, and the tray corresponds to a form of the blank material after being molded.

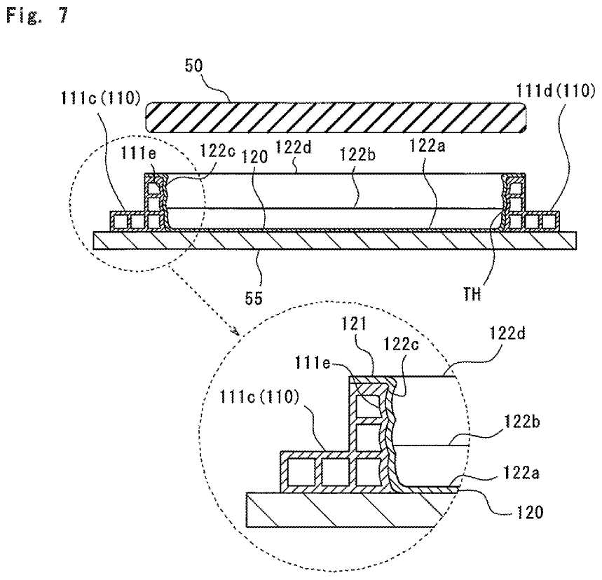

Next, with reference to FIGS. 6 and 7, the blank material 120 is pressurized to be pressed against the frame 110, so that the blank material 120 is deformed into the tray 120 of the bathtub shape and concurrently, the blank material 120 (tray 120) is joined to the frame 110 by press fitting. With this configuration, the blank material 120 (tray 120) and the frame 110 are integrally formed.

More in detail, in this embodiment, the blank material 120 is pressurized based on a pressure molding method. In the pressure molding method, a member is molded by air or fluid pressure. In this embodiment, in the pressure molding method, a fluid pressure transmitting elastic body 50, which is elastically deformable under the fluid pressure, is used. While not illustrated in detail, the fluid pressure transmitting elastic body 50 may, for example, have a configuration where a chamber of metal containing the fluid such as water or oil therein has only its lower surface closed with a rubber plate. With the fluid pressure adjusted, the rubber plate is elastically deformed, and the blank material 120 is molded without being brought into direct contact with the fluid.

With reference to FIGS. 5 and 6, in this embodiment, the frame 110, the blank material 120, and the fluid pressure transmitting elastic body, 50 are stacked in this sequential order and disposed on the base 55. Then, the blank material 120 is pressurized via the fluid pressure transmitting elastic body 50 by a pressing machine (not illustrated), causing the blank material 120 to be pressed against the frame 110.

With reference to FIG. 7, when the blank material 120 has been deformed into the tray 120 of the bathtub shape, pressurizing force from the pressing machine (not illustrated) is released. Then, the fluid pressure transmitting elastic body 50 returns to a shape of the initial state. Accordingly, the fluid pressure transmitting elastic body 50 is easily removed from inside of the tray 120. When the fluid pressure transmitting elastic body 50 has been removed, as illustrated in FIG. 2, the top cover 130 and the under cover 140 are joined to form the battery case 100.

In this embodiment, upper portions of the front wall 111a, the rear wall 111b, the side wall 111c, and the side wall 111d are respectively set to be greater in thickness than other portions thereof. The upper portions of the front wall 111a, the rear wall 111b, the side wall 111c, and the side wall 111d are respectively prone to be subjected to force caused by the molding. Thus, the greater thicknesses of these upper portions are configured to prevent the unintended deformation. Additionally, inner upper portions of the front wall 111a, the rear wall 111b, the side wail 111c, and the side wall 111d are respectively R shaped, thereby facilitating a material inflow of the blank material 120 in the molding.

With reference to FIG. 7, in this embodiment, when the blank material 120 is molded into the tray 120 of the bathtub shape, negative angle molding is conducted to form a negative angle at least partially from the bottom 122a toward an opening 122d of the tray 120. The “negative angle” is a term frequently used in a field of molding using a die, and indicates that the draft angle of the molded. member for release of the die is less than zero (i.e., a minus angle). In this embodiment, the negative angle molding is conducted as follows. The blank material 120 is pressurized via the fluid pressure transmitting elastic body 50 against the frame 110 that is not previously provided with a negative angle portion. Then, the frame 110 and the blank material 120 are integrally deformed, causing the negative angle to be formed. In an example of FIG. 7, the inner surface in each of the chambers of the frame 110 is deformed outward, causing the blank material 120 to be deformed outward. As a result, negative angle portions 111e and 122c are formed. In FIG. 7, a region circled in a broken line is enlarged such that the negative angle portions file and 122c are more clearly illustrated.

Effects of the battery case 100 and the method for manufacturing the battery case 100 will be described below.

In this embodiment, the blank material 120 is molded into the tray 120 of the bathtub shape and concurrently, is integrally formed with the frame 110. The blank material 120 of the flat plate shape is molded into the tray 120 of the bathtub shape, so that the tray 120 has no joint and is thus highly sealable. Additionally, the blank material 120 is molded into the tray 120 of the bathtub shape and concurrently, is joined to the frame 110, thereby simplifying the step of joining the tray (blank material) 120 to the frame 110. Here, the tray (blank material) 120 is joined to the frame 110 not by welding but by press-fitting, so that the joining is highly accurate without any thermal deformation. Accordingly, sufficient sealability of the battery case 100 is secured and concurrently, the tray 120 is simply, and highly accurately joined to the frame 110.

Further, with the pressure molding method, the tray 120 is no longer required to have the draft angle (inclination of side surface) as well as a ridgeline and a corner of the tray 120 may be less rounded, which is difficult to achieve in a typical cold press molding. Thus, it is possible to mold the blank material 120 into the tray 120 of any shape. The tray 120 is no longer required to have the draft angle, and may have the ridgeline and the corners less rounded. Accordingly, space efficiency of the battery case 100 is increased, resulting in the battery case 100 equipped with the battery 30 as a larger capacity battery.

When the blank material 120 is molded into the tray 120 of the bathtub shape, with the fluid pressure transmitting elastic body 50, the fluid for applying pressure does not scatter or leak. On an assumption that the fluid pressure transmitting elastic body 50 is not used in the pressure molding method, when the blank material 120 is deformed by, the fluid held at high pressure, an outer edge of the blank material 120 needs to be tightly restricted such that the fluid does not scatter or leak outside. On the other hand, with the fluid pressure transmitting elastic body 50, the fluid for applying force does not scatter or leak, so that the outer edge of the blank material 120 may be less tightly restricted. Accordingly, when the blank material 120 is molded into the bathtub shape, the material inflow from the outer edge is increased, and the blank material 120 is less prone to crack, thereby facilitating stable processing. Further, the outer edge of the blank material 120 no longer needs to be completely sealed, so that maintenance of the pressing machine and the die for restricting the cuter edge is easier, and productivity is improved.

Due to the negative angle molding, the negative angle is formed in the tray 120, and the negative angle portion 122c of the tray 120 engages with the negative angle portion 111e of the frame 110. With this configuration, the joining by press-fitting is less prone to be released. In other words, the negative angle molding is configured to increase strength of the joining between the frame 110 and the tray 120. Particularly, the negative angle molding is a characteristic of the pressure molding method, while with the cold press molding using a typical die and requiring the draft angle, a cam mechanism is additionally required and a structure of the typical die is thus further complicated.

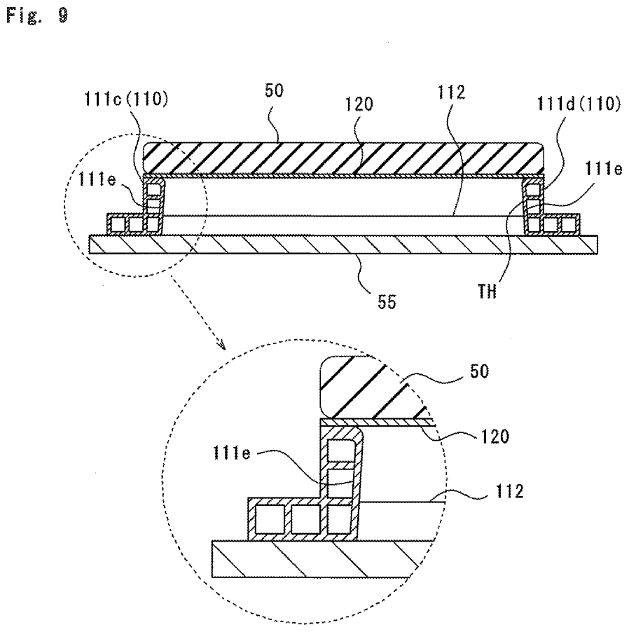

In this embodiment, particularly, the blank material 120, which is not previously provided with the negative angle portion, and the frame 110 are integrally deformed such that the negative angles are formed. With this configuration, the frame 110 is not necessarily previously provided with the negative angle portion 111e, unlike as illustrated in FIGS. 6 and 9 that will be described later. Accordingly, the negative angle molding is simply executed.

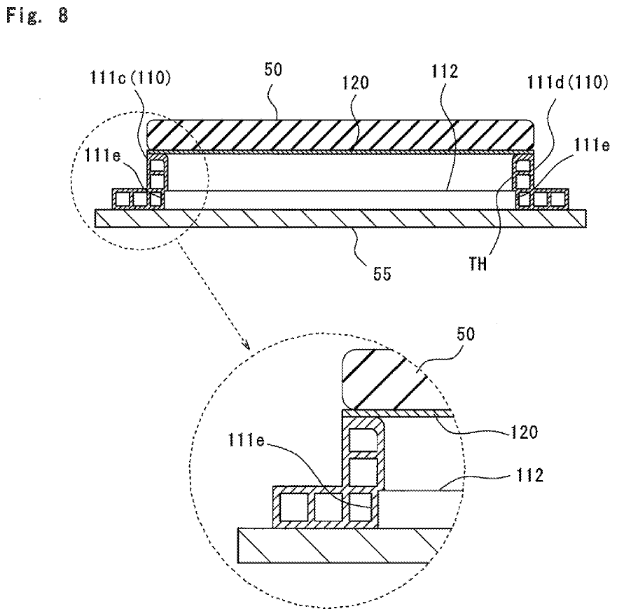

As a modification of the negative angle molding, the negative angle portion 111e may previously be formed in the frame 110 as illustrated in FIGS. 8 and 9. In this case, the blank material 120 is pressed against the negative angle portion 111e of the frame 110 such that the negative angle molding is conducted. In an example of FIG. 8, the negative angle portion 111e is formed as a recess on the inner surface of the frame 110. In an example of FIG. 9, the inner surface of the frame 110 is inclined toward a center of the frame 110 and, thereby, the negative angle portion 111e is formed as an inclined surface. The negative angle portion 111e may also be formed in the cross member 112. With the negative angle portion 111e previously formed in the frame 110, the negative angle molding is simply and reliably executed.

### (Second Embodiment)

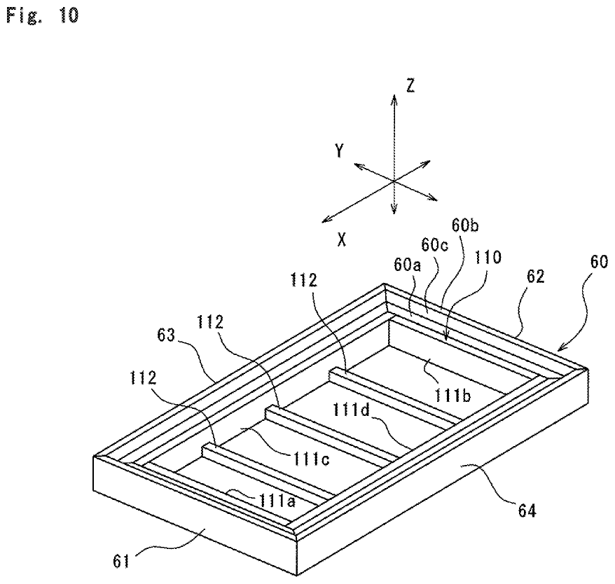

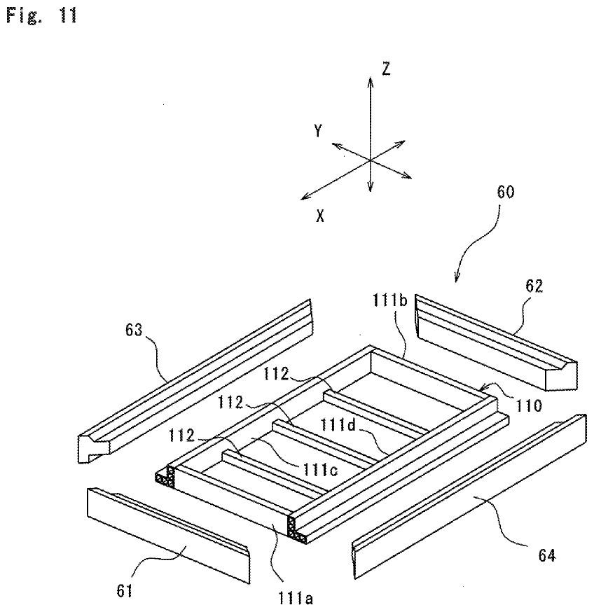

With reference to FIGS. 10 and 11, in the second embodiment, a restricting die 60 is used to restrict a movement of the frame 110. In this embodiment, the restricting die 60 is used, apart from which a method for manufacturing a battery case 100 is substantially identical to the method for manufacturing the battery case 100 according to the first embodiment. Therefore, descriptions of parts identical to those of the first embodiment may be omitted.

The restricting die 60 has a shape complementary to that of the frame 110, and is disposed at an outer side of the frame 110. The restricting die 60 includes a front restricting member 61, a rear restricting member 62, a side restricting member 63, and a side restricting member 64. The front restricting member 61 and the rear restricting. member 62 respectively support the front wall 111a and the rear wall 111b, and the side restricting members 63 and 64 respectively support the side walls 111c and 111d. The front restricting member 61, the rear restricting member 62, the side restricting members 63, and the side restricting member 64 are combined to form a frame shape in plan view. The restricting die 60 has its upper surface formed in two steps. Specifically, the upper surface of the restricting die 60 includes a first surface 60a aligned at a substantially equal height with an upper surface of the frame 110, and a second surface 60b placed one step higher than the upper surface of the frame 110. The first surface 60a and the second surface 60b are connected to each other with an inclined surface 60c, and the second surface 60b is disposed at an outer side of the first surface 60a in plan view. The frame 110 and the restricting die 60 are aligned in accordance with lower surface. Accordingly, when the frame 110 and the restricting. die 60 are compared in height dimension, the height of the restricting die 60 is set to be greater than that of the frame 110.

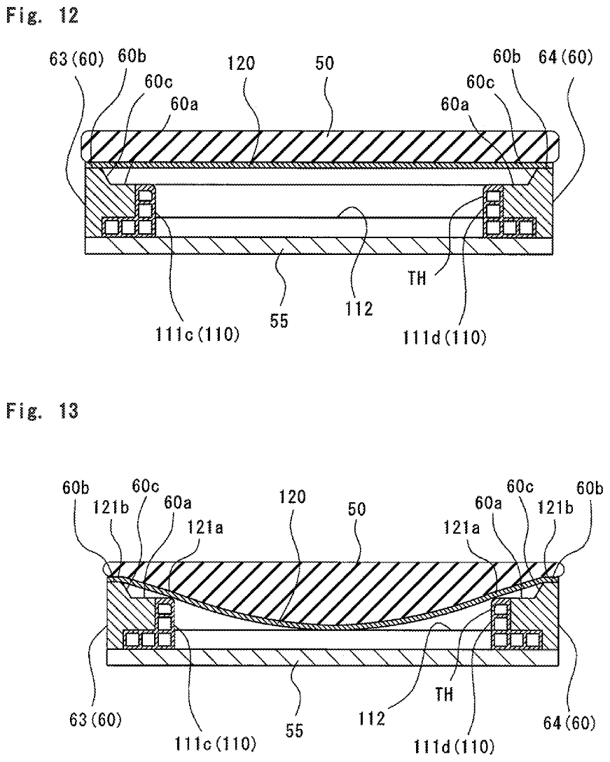

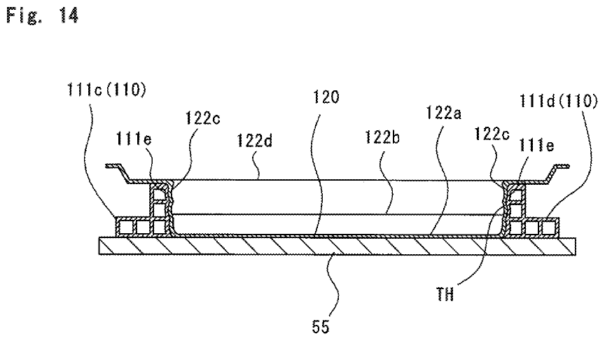

In the method for manufacturing the battery case 100 according to this embodiment, in addition to the steps of the first embodiment, the restricting die 60, which is configured to restrict the movement of the frame 110, is prepared; and the restricting die 60 is fixedly disposed to the outer side of the frame 110 in plan view (see FIG. 10). Then, as illustrated in FIGS. 12, 13, and 14, similarly to the first embodiment, the blank material 120 is deformed into the tray 120 of the bathtub shape and concurrently, is integrally formed with the frame 110.

Specifically, as illustrated in FIG. 12, the blank material 120 is disposed on the restricting die 60, and as illustrated in FIG. 13, the blank material 120 is pressurized via the fluid pressure transmitting elastic body 50. As a result, a first outer edge 121a of the blank material 120 is supported by the frame 110; and a second outer edge 121b (i.e., an outermost edge) , which is placed at an outer side of the first outer edge 121a (i.e., a portion placed slightly at an inner side of the outermost edge), is supported by the second surface 60b of the restricting die 60. With this configuration, the blank material 120 is disposed in a state of being deflected to be lower in height from its outer side toward. its inner side. Subsequently, the blank material 120 in this deflected state is pressurized to be deformed into the tray 120 of the bathtub shape and to be stably joined to the frame 110 by press-fitting.

In this embodiment, in the state where the blank material 120 is deflected to be lower in height from the outer side to the inner side, the blank material 120 is pressurized. As a result, the material inflow of the blank material 120 is increased, and the ridgeline and the corners at the bottom 122a of the tray 120 may be less rounded.

Embodiments and modifications of the present invention have been specifically described above; however, the present invention is not limited to the foregoing embodiments, and various changes and modifications may be made without departing from the scope of the present invention. For example, the respective elements described in the foregoing embodiments and modifications may be combined appropriately as an embodiment of the present invention.

For example, the frame 110 and the tray 120 may be formed of various types of materials. For example, the frame 110 may be formed of a roll formed sheet steel material, a pressed sheet steel product, or a combination thereof; and the tray 120 may be formed of a sheet steel. The frame 110 and the tray 120 are both formed of steel members. With this configuration, the battery case 100 is reduced in cost and increased in strength and concurrently, is no longer required for a countermeasure against electrolytic corrosion. Thus, the battery case 100 is more easily handled.

Alternatively, for example, the frame 110 may be formed.

of the aluminum alloy extruded product, the aluminum alloy cast product, the magnesium alloy extruded product, the magnesium alloy cast product, or the combination thereof; and the tray 120 may be formed of a coated sheet steel or a laminated sheet steel. The frame 110 is formed of the aluminum alloy member or the magnesium alloy member, so that the battery case 100 is reduced in weight. Further, the tray 120 is formed of the coated (or laminated) sheet steel, so that the battery case 100 is reduced in cost and increased. in strength, and concurrently, the coating film prevents the electrolytic corrosion. Particularly, in a field of multi-material manufacturing using different types of metals such as an aluminum alloy member with a steel member a magnesium alloy member with a steel member, it is difficult to weld these different types of metals. On the other hand, in each of the foregoing embodiments, the frame 110 and the tray 120 are joined not by welding but by press-fitting, thereby enabling the multi-material manufacturing and resulting in the battery case 100 that is reduced in weight and increased in strength.

The blank material may be pressurized based on the pressure molding method (that has been described in each of the foregoing embodiments) as step 2, and the blank material may be previously pressurized by the cold press molding as step 1. In this case, preferably, between when the blank material 120 is pressurized in the step 1 and when the blank material 120 is pressurized in the step 2, the blank material 120 is subjected to softening heat treatment. The blank material 120 is molded in the two separate steps in a stepwise manner. Here, pressurizing force is reduced as compared with a case where the blank material 120 is completely molded in one step only, and the blank material 120 is thus stably molded. Further, the softening heat treatment can remove a processing distortion of the blank material 120 caused by the pressurization in the step 1. elasticity of the material can be restored, and thus the ridgeline and the corners of the tray 120 may be less rounded.

### DESCRIPTION OF SYMBOLS

1 Electric vehicle

10 Vehicle body front section

20 Vehicle body central section

30 Battery

50 Fluid pressure transmitting elastic body

55 Base

60 Restricting die

60a First surface

60b Second surface

60c Inclined surface

61 Front restricting member

62 Rear restricting member

63, 64 Side restricting member

100 Battery case (battery case for electric vehicle)

110 Frame

111 Frame shaped body

111a Front wall

111b Rear wall

111c, 111d Side wall

111e Negative angle portion

112 Cross member

120 Tray (blank material)

121 Flange

121a First outer edge

121b Second outer edge

122 Accommodating portion

122a Bottom

122b Protruding portion

122c Negative angle portion

122d Opening

130 To cover

140 Under cover

200 Rocker member

300 Floor panel

400 Floor cross member

1. A method for manufacturing a battery case for electric vehicle, the method comprising:
preparing a frame, and a blank material formed in a flat plate shape;
disposing the frame and the blank material to stack the blank material on the frame; and
pressurizing the blank material to press the blank material against the frame, so as to mold the blank material into a bathtub shape and joining the blank material to the frame by press-fitting.

2. The method for manufacturing the battery case for electric vehicle according to claim 1, wherein the blank material is pressurized based on a pressure molding method.

3. The method for manufacturing the battery case for electric vehicle according to claim 2, further comprising:
further preparing a fluid pressure transmitting elastic body that is elastically deformable under fluid pressure;
disposing the fluid pressure transmitting elastic body to stack it on the blank material that has been stacked on the frame; and
pressurizing the blank material via the fluid pressure transmitting elastic body to press the blank material against the frame.

4. The method for manufacturing the battery case for electric vehicle according to claim 2, wherein, before the blank material is pressurized based on the pressure molding method, the blank material is pressurized by cold press molding.

5. The method for manufacturing the battery case for electric vehicle according to claim 4, wherein, between when the blank material is pressurized based on the pressure molding method and when the blank material is pressurized by the cold press molding, the blank material is subjected to softening heat treatment.

6. The method for manufacturing the battery case for electric vehicle according to claim 2, wherein when the blank material is molded into a tray of a bathtub shape, negative angle molding is conducted to form a negative angle at least partially from a bottom of the tray of the bathtub shape toward an opening of the tray of the bathtub shape.

7. The method for manufacturing the battery case for electric vehicle according to claim 6, wherein
before the blank material is pressurized, the frame includes a negative angle portion where the negative angle is previously formed, and
in the negative angle molding, the blank material is pressed against the negative angle portion of the frame.

8. The method for manufacturing the battery case for electric vehicle according to claim 6, wherein, in the negative angle molding, the blank material is pressurized to be integrally deformed with the frame, causing the negative angle to be formed.

9. The method for manufacturing the battery case for electric vehicle according to claim 1, further comprising:
further preparing a restricting die having a height dimension greater than that of the frame and configured to restrict a movement of the frame;
disposing the restricting die fixedly to an outer side of the frame;
supporting a first outer edge of the blank material by the frame and supporting a second outer edge of the blank material by the restricting die, the second outer edge being at an outer side of the first outer edge, so as to dispose the blank material in a state where the blank material is deflected to be lower in height from an outer side of the blank material toward an inner side of the blank material; and
pressurizing the blank material in the state where the blank material is deflected.

10. A battery case for electric vehicle comprising:
a frame; and
a tray having a bathtub shape, disposed inside the frame, and joined to the frame by press-fitting,
wherein
in joining of the tray to the frame by press-fitting, the tray includes a negative angle portion where a negative angle is formed at least partially inward from a bottom of the tray toward an opening of the tray.

11. The battery case for electric vehicle according to claim 10, wherein
the frame is formed of an aluminum alloy extruded product, an aluminum alloy cast product, a magnesium alloy extruded product, a magnesium alloy cast product, or a combination of any one of the aluminum alloy extruded product, the aluminum alloy cast product, the magnesium alloy extruded product, and the magnesium alloy cast product, and
the tray is formed of an aluminum alloy or a magnesium alloy.

12. The battery case for electric vehicle according to claim 10, wherein
the frame is formed of a roll formed sheet steel material, a pressed sheet steel product, or a combination of the roll formed sheet steel material and the pressed sheet steel product, and
the tray is formed of a sheet steel.

13. The battery case for electric vehicle according to claim 10, wherein
the frame is formed of an aluminum alloy extruded product, an aluminum alloy cast product, a magnesium alloy extruded product, a magnesium alloy cast product, or a combination of any one of the aluminum alloy extruded product, the aluminum alloy cast product, the magnesium alloy extruded product, and the magnesium alloy cast product, and
the tray is formed of a coated sheet steel or a laminated sheet steel.

14. The battery case for electric vehicle according to claim 11, wherein the frame includes a cross member.

15. The method for manufacturing the battery case for electric vehicle according to claim 3 wherein, before the blank material is pressurized based on the pressure molding method, the blank material is pressurized by cold press molding.

16. The method for manufacturing the battery case for electric vehicle according to claim 15, wherein, between when the blank material is pressurized based on the pressure molding method and when the blank material is pressurized by the cold press molding, the blank material is subjected to softening heat treatment.

17. The method for manufacturing the battery case for electric vehicle according to claim 16, wherein
before the blank material is pressurized, the frame includes a negative angle portion where the negative angle is previously formed, and
in the negative angle molding, the blank material is pressed against the negative angle portion of the frame.

18. The method for manufacturing the battery case for electric vehicle according to claim 16, wherein, in the negative angle molding, the blank material is pressurized to be integrally deformed with the frame, causing the negative angle to be formed.

19. The method for manufacturing the battery case for electric vehicle according to claim 2, further comprising:
further preparing a restricting die having a height dimension greater than that of the frame and configured to restrict a movement of the frame;
disposing the restricting die fixedly to an outer side of the frame;
supporting a first outer edge of the blank material by the frame and supporting a second outer edge of the blank material by the restricting die, the second outer edge being at an outer side of the first outer edge, so as to dispose the blank material in a state where the blank material is deflected to be lower in height from an outer side of the blank material toward an inner side of the blank material; and
pressurizing the blank material in the state where the blank material is deflected.

20. The method for manufacturing the battery case for electric vehicle according to claim 3, further comprising:
further preparing a restricting die having a height dimension greater than that of the frame and configured to restrict a movement of the frame;
disposing the restricting die fixedly to an outer side of the frame;
supporting a first outer edge of the blank material by the frame and supporting a second outer edge of the blank material by the restricting die, the second outer edge being at an outer side of the first outer edge, so as to dispose the blank material in a state where the blank material is deflected to be lower in height from an outer side of the blank material toward an inner side of the blank material; and
pressurizing the blank material in the state where the blank material is deflected.
